(19) United States
(12) Patent Application Publication
(10) Pub. No.: US 2026/0228959 A1
(43) Pub. Date: Aug. 6, 2026

(54) Method for Artificially Generating Multiple Images

(71) Applicants: ROBERT BOSCH GmbH, Stuttgart (DE); CARIAD SE, Wolfsburg (DE)

(72) Inventor: Alexander Kugele, Kornwestheim (DE)

(21) Appl. No.: 19/458,594

(22) Filed: Jan. 23, 2026

(30) Foreign Application Priority Data
Jan. 31, 2025 (DE) 10 2025 103 733.7

(51) Int. Cl. G06T 15/20

(52) U.S. Cl. CPC G06T 15/20

(57) ABSTRACT

The invention relates to a method for artificially generating multiple images of a three-dimensional scene, in particular for provision as training and/or validation and/or test data for a machine learning system for use in a technical system, preferably a vehicle, wherein the following steps are performed automatically:
Providing input data wherein the input data at least partially describes the scene,
Generating the multiple images by an image generator to represent the scene through the generated images via different views, wherein the image generator uses at least one machine learning model for the generation,
Providing the generated images.

The invention relates to a method for artificially generating multiple images. The invention also relates to a computer program, an apparatus, and a storage medium for this purpose.

### BACKGROUND

The generation of images is an active field of research in the area of computer vision and generative models. Diffusion models in particular have gained importance in recent years because they are capable of producing high-quality images by formulating the process of image generation as a step-by-step conversion of noise into a structured image.

Diffusion models, as described in the work of Ho et al. (2020) entitled “Denoising Diffusion Probabilistic Models” (see [1], with references provided at the end of the description), use a two-step process: First, an image is converted into noise, and then a model is trained to gradually remove the noise and generate a realistic image. These models have proven to be extremely effective and achieve impressive results in image synthesis.

Concrete examples of this type of model include Stable Diffusion [2] and Imagen [3]. What these models have in common is that they generate a single image based on an input. The input may be text, an image, an abstract scene, or similar. Variants of these are also possible, such as ControlNet, which offers more precise control over scene design.

In many areas, however, generating a single image is not sufficient, as a complex scene is captured by multiple cameras. This is the case, for example, in automated driving, 3D reconstruction, or film production. The problem arises especially when an object is visible in multiple cameras. The generative models available to date cannot guarantee that an object will look the same in the different generated images.

### SUMMARY

The subject matter of the invention is a method with the features of claim 1, a computer program with the features of claim 8, an apparatus with the features of claim 9, and a computer-readable storage medium with the features of claim 10. Further features and details of the invention are apparent from the respective subclaims, the description, and the drawings. Features and details described in connection with the method according to the invention also apply in connection with the computer program according to the invention, the apparatus according to the invention, and the computer-readable storage medium according to the invention, and vice versa, so that mutual reference is always possible with regard to the disclosure of the invention.

The subject matter of the invention is, in particular, a method for artificially generating, i.e., in particular image synthesis, multiple images of a three-dimensional scene, in particular for provision as training and/or validation and/or test data for a machine learning system, preferably for use in a technical system, preferably a vehicle and/or robot.

The method according to the invention may comprise the following steps, which are preferably performed automatically:
Providing input data, wherein the input data at least partially describes the scene and, for example, specifically describes one or more objects of the scene with regard to their visual properties and/or arrangement,
Generating the multiple images using an image generator to represent and preferably display the scene through the generated images, in particular via different views, wherein the image generator preferably uses at least one machine learning model, such as a diffusion model, for the generation,
Providing the generated images.

It is possible that the multiple images are generated jointly by the image generator in order to preferably take into account information shared by the input data and/or the multiple images for the generation by the image generator. This has the advantage that the scene may be represented via the different views (in particular perspectives and/or cameras), and objects of the scene that may be seen in several of the views (in particular simultaneously) are represented more consistently.

In this way, it is also possible to generate artificial images of a scene—and preferably also to train a machine learning system—with higher quality and efficiency. In particular, the described method, in which multiple images are generated together in a single step, ensures a more consistent representation of the scene. The method may also enable the generation of images for use as training data for various areas of application, e.g., in object recognition and autonomous driving.

Preferably, in the method according to the invention, the multiple images may be generated jointly (by the image generator), i.e., in particular in a same step, i.e., preferably in one dimension and/or in parallel.

Furthermore, within the scope of the invention, it is optionally possible that generating the images comprises:
Transforming the input data by an encoder, preferably a BEV encoder, into an abstract feature space, in particular a BEV representation or a three-dimensional tensor, in particular to perform a transformation into a bird's-eye view,
Transforming the abstract feature space by a decoder, preferably a BEV decoder, into an output tensor, which comprises the generated images as individual images.

This feature space therefore preferably represents the scene from a bird's-eye view and facilitates the generation of consistent images with different viewing angles.

In the context of the invention, BEV stands for bird's eye view, also known as a top view, which may be characterized by at least one of the following features:
The viewing angle is directed from above or diagonally above,
The horizon is above the center of the image or outside the image.

A BEV encoder (Bird's Eye View Encoder) may refer to a type of encoder in a neural network, known as such from the prior art, which serves to transform data into a bird's eye view. Accordingly, a BEV decoder may be used for reverse transformation.

Furthermore, it is conceivable that the input data comprises at least one of the following:
A text description of the scene,
A scene layout of the scene,
At least a two-dimensional representation of the scene, preferably in the form of an input image,
A description of a position and/or orientation of a camera, in particular a virtual camera, as a point of origin for the different views,
One or more 2D or 3D boxes representing coordinates and descriptions for predefined objects in the scene.

It is therefore possible to design the input data in a variety of ways to give the image generator a comprehensive understanding of the scene. This may lead to improved accuracy and consistency of the generated images. The various forms of description allow both global aspects such as text descriptions and local details such as the positions and orientations of objects to be included.

Furthermore, it is conceivable that the images are generated in order to artificially create, i.e., synthesize, the different views and thus expand a data base about the scene. It is thus possible that the artificial generation of images from different perspectives may generate a comprehensive data set for the training data. This enables machine learning systems to capture a more accurate and detailed representation of the scene, thereby improving their performance in applications such as object recognition and scene understanding.

According to a further advantage, it may be provided that the multiple images are generated jointly as individual images in the same step by the image generator, so that the image generator also uses information from the other individual images during the generation of one of the individual images, and thus takes it into account as the shared information, i.e., the information shared by the input data and/or the multiple images for the generation by the image generator. In other words, the simultaneous generation of all images by the image generator enables a consistent representation of the scene. By processing all scene understanding information together through the generator, all individual images may be generated in the same step, resulting in more efficient image generation.

Furthermore, the invention may provide that the image generator uses at least one diffusion model as the at least one machine learning model for the generation. Therefore, the model may benefit from the advantages of the diffusion model, such as high image quality and the ability to generate realistic images. The use of a diffusion model as a machine learning model allows flexible adaptation to different scenes and object types.

In a further possibility, it may be provided that the generated images are used as training and/or validation and/or test data for a machine learning system for use in a technical system, preferably in a vehicle and/or robot, to train the machine learning system to perform classification and preferably pixel-based object detection, preferably to control the technical system based on a result of the classification, wherein the scene is preferably implemented as a traffic scene and/or as a scene in an industrial facility of the robot. In this way, the model may contribute to improving object recognition in complex scenes by generating training data for machine learning systems.

It is possible that the method according to the invention and/or the machine learning system may be used in a vehicle. The vehicle may, for example, be designed as a motor vehicle and/or passenger car and/or at least partially automated/autonomous vehicle. The vehicle may have a vehicle device, for example, for providing an autonomous driving function and/or a driver assistance system. The vehicle device may be designed to control and/or accelerate and/or brake and/or steer the vehicle at least partially automatically.

The method according to the invention may be used to enrich a data base with the generated images in order to subsequently use the data base as a training data set. The machine learning system, in particular in the form of a machine learning model, is trained using the generated images, in particular for classification and in particular for object detection. The training may be intended to train the machine learning system or the machine learning model using the training data set for classification, in particular for image classification, of image data such as digital images based on image points and/or pixels, in particular pixel values, preferably edges or pixel attributes (of the image data). The image data or digital images may result, for example, from a recording by at least one sensor, preferably at least one camera, preferably of a vehicle, and particularly preferably a camera environment and/or vehicle environment while driving or during a drive (of a vehicle). The recording is possible, for example, by at least one camera of the vehicle. The classification may be intended to recognize objects in an environment depicted by the image data or digital images and/or to capture a traffic scene.

The classification may be intended for various technical applications. One example is the application in a vehicle and/or in a robot. Based on the classification, in particular at least one classification result, at least one control action, preferably for a vehicle, the robot, or for another technical system, may be initiated and/or performed.

A classification result may comprise at least one of the following results and/or be specific to at least one of the following results: a category of objects, an identification of objects, a position of objects and/or obstacles (e.g., in the direction of travel or next to the direction of travel), a presence of obstacles, a description of a traffic scene, a hazard warning, a number of objects, a type and/or position of lane markings and/or a lane boundary, a position and/or condition of traffic signal systems, a position of a lane, or the like.

Based on the classification result, at least one control action for the vehicle may be initiated and/or performed. The control action may comprise at least one of the following: braking, steering, accelerating, overtaking, emergency braking, activating an alarm system, activating hazard warning lights, activating a turn signal, light control, or the like.

The classification may be used, for example, to detect an obstacle, regardless of whether it is directly in the direction of travel or next to the direction of travel. Depending on the location (e.g., depending on the predicted vehicle trajectory), a corresponding control action such as braking or evasive maneuvering may be initiated.

For example, braking may also be initiated if the classification shows that there are obstacles in the direction of travel and/or a collision is likely. It is also conceivable that a roadway and/or a roadway boundary may be detected based on the classification in order to move the vehicle at least partially automatically on the roadway by means of the control action.

“Classification” and “image classification” may also include “object detection” or “object detection in images”. This refers in particular to a classification of whether or not objects are present in certain areas of the image. In addition, the terms “classification” and “image classification” may also refer to “semantic segmentation”, in particular in the form of pixel-by-pixel classification.

Accordingly, the training may result in at least one trained machine learning model that may be used for classification and/or object detection. The use and thus the inference may be provided for in a vehicle, for example. The data points of the input data may be pixels of image data, for example, or be based on these in order to perform the classification and/or object detection of the data points based on the pixels. The input data may comprise sensor data and/or image data which results at least in part from acquisition with a sensor, preferably a camera sensor, and/or which have been at least partially synthesized, i.e., in particular, which replicate the real data of a sensor. Specifically, it may be provided that the values of image points, preferably pixels, of the image data represent an environment of a sensor and/or a vehicle and/or a traffic scene. Classification, preferably image classification and/or object detection, may be provided based on these values. This makes it possible, for example, to detect objects in the traffic scene. The image data may be, for example, images from a radar sensor and/or an ultrasonic sensor and/or a LiDAR sensor and/or a thermal imaging camera. Accordingly, the images may also be radar images and/or ultrasonic images and/or thermal images and/or LiDAR images.

The invention also relates to a computer program, in particular a computer program product, comprising instructions which, when the computer program is executed by at least one computer, cause the computer to execute the method according to the invention. The computer program according to the invention thus offers the same advantages as those described in detail with reference to a method according to the invention.

The invention also relates to a data processing apparatus configured to execute the method according to the invention. The apparatus may, for example, comprise at least one computer that executes the computer program according to the invention. The computer may have at least one processor for executing the computer program. A non-volatile data storage device may also be provided, in which the computer program is stored and from which the computer program may be read by the processor for execution.

The invention may also relate to a computer-readable storage medium that comprises the computer program according to the invention and/or comprises instructions which, when executed by at least one computer, cause the computer to execute the method according to the invention. The storage medium is designed, for example, as a data storage device such as a hard disk and/or a non-volatile memory and/or a memory card. The storage medium may, for example, be integrated into the computer.

In addition, the method according to the invention may also be implemented as a computer-implemented method. Alternatively or additionally, at least one of the disclosed method steps may be computer-implemented and/or performed automatically.

### BRIEF DESCRIPTION OF THE DRAWINGS

Further advantages, features, and details of the invention are apparent from the following description, in which embodiments of the invention are described in detail with reference to the drawings. The features mentioned in the claims and in the description may be essential to the invention individually or in any combination. The figures showing:

FIG. 1 a schematic representation of a method, an apparatus, a storage medium, and a computer program according to embodiments of the invention.

FIG. 2 a further schematic representation of the method according to embodiments of the invention.

### DETAILED DESCRIPTION

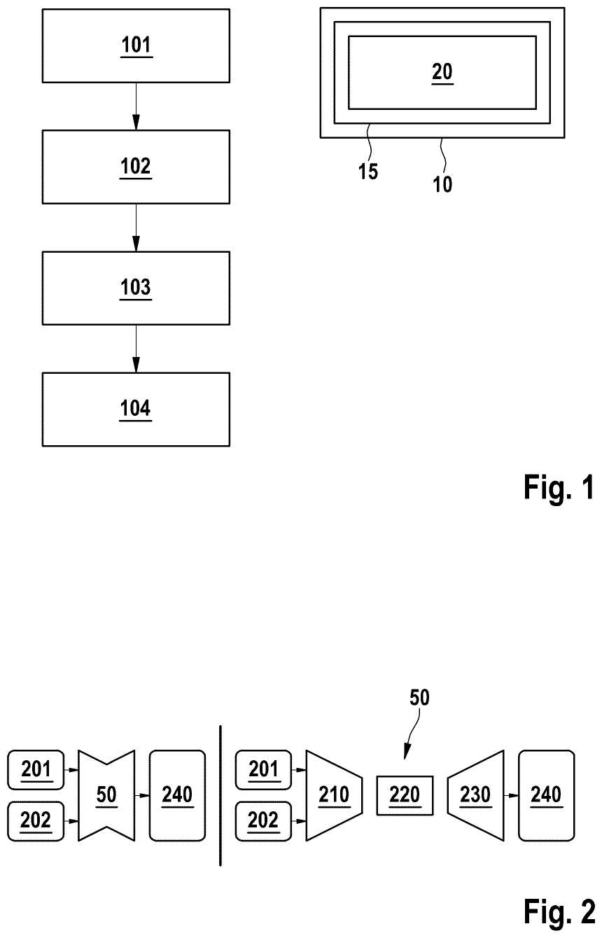

FIG. 1 schematically shows a method 100, an apparatus 10, a storage medium 15, and a computer program 20 according to embodiments of the invention. FIG. 1 further illustrates, according to embodiments of the invention, the application of the method 100 for the artificial generation of multiple images of a three-dimensional scene.

According to a first method step 101, provision of input data 201, 202 may be provided, wherein the input data 201, 202 at least partially describes the scene. According to a second method step 102, the multiple images may be generated, i.e., preferably synthesized, by an image generator 50 to represent the scene through the generated images through different views. The image generator 50 may use at least one machine learning model for the generation. According to a third method step 103, the generated images are provided. It is conceivable that the multiple images are generated jointly by the image generator 50 in order to jointly take into account information shared by the input data 201, 202 and/or the multiple images for the generation 102 by the image generator 50. It is also conceivable, as represented in particular by a fourth method step 104, that the images generated in this way are used in the training of a machine learning system.

The generation 102 of the images may further comprise, according to FIG. 2:
Transforming the input data 201, 202 by an encoder 210, preferably a BEV encoder, into an abstract feature space 230, in particular a BEV representation or a three-dimensional tensor, in particular to perform a transformation into a bird's-eye view BEV,
(Re-)transforming the abstract feature space by a decoder 230, preferably a BEV decoder, into an output tensor 240, which comprises the generated images as individual images.

Conventional solutions are already known for processing multi-view camera images and, for example, detecting objects [7]. However, these are often unable to generate new images.

In order to enable consistent generation of a scene, a new network architecture (and several variants) is therefore proposed in accordance with embodiments of the invention. A fundamental idea of embodiments is that all images of a scene are generated simultaneously to ensure consistency. This may be achieved by generating multiple images as a related stack, as shown in more detail in FIG. 2.

In the embodiment shown, the network architecture receives an input that describes the scene. This may be, for example, a text input 201 or a layout 202 such as a number of 3D boxes or similar. This input is transformed by an encoder 210 into an abstract feature space. This may be, for example, a BEV representation 220, or a general 3D tensor. This is converted by a decoder 230 into a tensor 240 of the form
cl Height Times Width Times #channels Times #frames

(H, W, N*C). By treating all images in the same dimension, consistent images may be generated.

There are already two methods that have a similar structure in name but differ in how they work. Therefore, these are described in more detail here.

In [5], an approach is described that combines diffusion models and a bird's eye view (also known as BEV) to improve the prediction of relevant objects in a scene. This may be, for example, semantic segmentation based on multiple camera images. In comparison, in embodiments of the invention, new camera images are generated, in particular based on a scene description.

In [6], the generation of the different views is realized by a text input that describes the position of the camera. Thus, during the generation of a single image, the network has no information about the other images. In comparison, in embodiments of the invention, all images are generated in the same step, preferably in the same dimension.

Generating all images jointly ensures that a consistent scene is generated. In principle, it also saves resources (runtime, energy) compared to conventional approaches that generate N images sequentially instead of generating all N images in parallel.

Variants of the invention serve to generate multiple camera images of a scene. These may be used to train a network that detects objects or similar items in the scenes. A model that is trained or evaluated with the generated data of the invention may perform better on the desired tasks.

The diffusion model weights of a diffusion model 50 may also be quantized to further increase runtime and energy efficiency.

Embodiments of the invention may include an encoder part 210. The encoder part may be implemented as a neural network (or part of a neural network) that creates an abstract representation of the scene based on a text input or a scene layout.

Furthermore, embodiments of the invention may comprise a decoder part 230. The decoder part may be implemented as a neural network (or part of a neural network) that generates multiple camera images based on the abstract representation.

The network may be designed such that the abstract representation is a BEV representation. The network may also be designed such that it generates the images in a diffusion process.

The input data, and in particular the scene layout, may have the following structure, among others:
1. Multiple text inputs with associated positions. Each text input describes a part of the scene.
2. One or more 2D or 3D boxes that are coordinates and descriptions for specific objects.
3. An abstract scene (e.g., drawing, Canny edges, or similar).
4. Images of a similar scene.

Like conventional diffusion models, the network may also be used for scene-to-scene transformations (in Stable Diffusion: image-to-image). To do this, the inversion process (e.g., direct inversion) is applied to the network by inputting several camera images. This may be used, for example, to modify an existing scene, which may be either real or generated.

Implementation variants of the invention may be based on and extend at least one of the following references:
[1] Ho, Jonathan, Ajay Jain, and Pieter Abbeel. “Denoising diffusion probabilistic models.” Advances in neural information processing systems 33 (2020): 6840-6851.
[2] Rombach, Robin, et al. “High-resolution image synthesis with latent diffusion models.” Proceedings of the IEEE/CVF conference on computer vision and pattern recognition. 2022.
[3] Saharia, Chitwan, et al. “Photorealistic text-to-image diffusion models with deep language understanding.” Advances in neural information processing systems 35 (2022): 36479-36494.
[4] Zhang, Lvmin and Rao, Anyi and Agrawala, Maneesh. “Adding Conditional Control to Text-to-Image Diffusion Models”, IEEE International Conference on Computer Vision (ICCV) (2023).
[5] Zou, Jiayu, et al. “Diffbev: Conditional diffusion model for bird's eye view perception.” Proceedings of the AAAI Conference on Artificial Intelligence. Vol. 38. No. 7. 2024.
[6] Xu, Xiaojie, et al. “From Bird's-Eye to Street View: Crafting Diverse and Condition-Aligned Images with Latent Diffusion Model.” 2024 IEEE International Conference on Robotics and Automation (ICRA). IEEE, 2024.
[7] Li, Zhiqi, et al. “Bevformer: Learning bird's-eye-view representation from multi-camera images via spatiotemporal transformers.” European conference on computer vision. Cham: Springer Nature Switzerland, 2022.

The foregoing description of the embodiments describes the present invention exclusively in the context of examples. Of course, individual features of the embodiments may be freely combined with each other, provided that this is technically feasible, without departing from the scope of the present invention.

1. A method for artificially generating multiple images of a three-dimensional scene, wherein the following steps are performed automatically:
Providing input data, wherein the input data at least partially describes the scene,
Generating the multiple images using an image generator to represent the scene through the generated images via different views, wherein the image generator uses at least one machine learning model for the generation,
Providing the generated images, characterized in that
the multiple images are generated jointly by the image generator in order to jointly take into account information shared by the input data, and/or the multiple images for the generation by the image generator.

2. The method according to claim 1, characterized in that
generating the images comprises:
Transforming the input data by an encoder
Transforming an abstract feature space by a decoder into an output tensor which comprises the generated images as individual images.

3. The method according to claim 1,
characterized in that
the input data comprises at least one of the following:
A text description of the scene,
A scene layout of the scene,
At least a two-dimensional representation of the scene,
A description of a position and/or orientation of a camera, as a starting point for the different views,
One or more 2D or 3D boxes representing coordinates and descriptions for predefined objects.

4. The method according to claim 1,
characterized in that
the images are generated in order to artificially create the different views and thus expand a data base about the scene.

5. The method according to claim 1,
characterized in that
the multiple images are generated jointly as individual images in the same step by the image generator, so that the image generator also uses information from the other individual images during the generation of one of the individual images, and thus takes it into account as the shared information.

6. The method according to claim 1,
characterized in that
the image generator uses at least one diffusion model as the at least one machine learning model for the generation.

7. The method according to claim 1,
characterized in that
the generated images are used as training and/or validation and/or test data for a machine learning system for use in a technical system to train the machine learning system to perform classification.

8. (canceled)

9. A data processing comprising:
one or more processors; and
a computer program comprising instructions stored on a non-transitory computer-readable medium, the computing instructions, when executed by the one or more processors cause the one or more processors to:
Providing input data, wherein the input data at least partially describes the scene,
Generating the multiple images using an image generator to represent the scene through the generated images via different views, wherein the image generator uses at least one machine learning model for the generation,
Providing the generated images,
characterized in that
the multiple images are generated jointly by the image generator in order to jointly take into account information shared by the input data and/or the multiple images for the generation by the image generator.

10. A non-transitory computer-readable storage medium, comprising instructions which, when executed by at least one computer, cause it to:
Provide input data, wherein the input data at least partially describes the scene,
Generate the multiple images using an image generator to represent the scene through the generated images via different views, wherein the image generator uses at least one machine learning model for the generation,
Provide the generated images,
characterized in that
the multiple images are generated jointly by the image generator in order to jointly take into account information shared by the input data and/or the multiple images for the generation by the image generator.

11. The method according to claim 2 wherein at least one of:
wherein the encoder is a BEV encorder;
wherein the abstract feature space is a BEV representation or a three-dimensional tensor;
wherein transforming the input data by the encoder comprises to perform a transformation into a bird's-eye view (BEV); or
wherein the decoder comprises a BEV decoder.

12. The method according to claim 3 wherein the camera is a video camera.

13. The method according to claim 7 wherein at least one of:
wherein the technical system is a vehicle and/or a robot;
wherein the classification comprises pixel-based object detection;
wherein the technical system is controlled based on a result of the classification; or
wherein the scene is implemented as a traffic scene and/or as a scene in an industrial facility of the robot.
